(19) United States
(12) Patent Application Publication
(10) Pub. No.: US 2009/0327182 A1
(43) Pub. Date: Dec. 31, 2009

(54) CALENDAR BASED PERSONALIZED RECOMMENDATIONS

(75) Inventors: Payal Chakravarty, Raleigh, NC (US); Ashish Jain, Raleigh, NC (US)

Correspondence Address: CANTOR COLBURN LLP-IBM BURLINGTON, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/147,597

(22) Filed: Jun. 27, 2008

(51) Int. Cl. G06N 5/00

(52) U.S. Cl. 706/45

(57) ABSTRACT

A method providing intelligent suggestions and recommendations for wearable attire and digital program recording, includes: receiving information for a user's apparel and accessory purchases; parsing the received information for storage in a database to form an inventory of the user's apparel and accessories; obtaining ancillary information from mass media sources, the Internet, and calendar applications; providing the received information and the obtained ancillary information to a suggestion interface; formulating recommendations with the suggestion interface for wardrobe and program recording options; wherein the wardrobe options are based on the inventory of the user's apparel and accessories; and wherein the received information comprises one or more of the following: electronic receipts for apparel and accessory purchases, radio frequency identification (RFID) tags on the apparel and accessories, and information describing the apparel and accessories supplied by manual user entry via a graphical user interface.

### BACKGROUND

This invention relates generally to recording devices in communication systems, and more particularly to enhanced applications and features related to digital recording devices.

The availability and use of digital video and media content has grown tremendously in the last decade, and will soon virtually replace all analog transmission and recording.

A widespread application of digital video is Digital television (DTV). DTV is a telecommunication system for broadcasting and receiving moving pictures and sound by means of a digital signal, in contrast to an analog signal used by analog (traditional) TV. DTV utilizes the digital modulation of analog signal data, which is digitally compressed prior to recording or broadcast. The digitally compressed signal requires decoding by a specially designed receiver within a television set, or a standard receiver with a set-top box, or a PC fitted with a television card. Digital television has several advantages over traditional analog TV, the most significant being that digital channels take up less bandwidth space. The reduced bandwidth of a digital broadcast signal enables digital broadcasters to provide more digital channels in the same space, provide High-Definition (HD) digital service, or provide other non-television services such as pay-multimedia services or interactive services. Digital television also permits special services such as multicasting (more than one program on the same channel), electronic program guides, program identification, and program descriptions.

The Federal Communications Commission (FCC), the branch of the United States (U.S.) government that regulates the television and radio broadcast industries, has mandated that all U.S. television broadcasts will be exclusively digital as of Feb. 17, 2009. Furthermore, as of Mar. 1, 2007, all new television sets that can receive signals over-the-air, including pocket-sized portable televisions, must include digital or HDTV tuners so they can receive digital broadcasts.

Along with the recent advances in television broadcasting, consumers have been introduced to digital recording devices that utilize the latest advances in broadcasting, computing, and storage mediums. An example of a digital recording device is the digital video recorder (DVR) or personal video recorder (PVR) (herein referred to as a DVR) that records video in a digital format to a disk drive or other storage medium. Digital video recording includes stand-alone set-top boxes, and software for enabling personal computers, portable communication devices, and portable computing devices to perform video capture and playback to and from a storage or recordable medium.

DVRs provide several user advantages and enhancements to older generation recording devices such as video cassette recorders (VCRs), including convenient “time shifting”. Additionally, a DVR enables “trick modes” such as pausing live TV, instant replay of scenes, chasing playback, and commercial advertising skipping. DVRs most commonly use variants of the Moving Pictures Experts Group (MPEG) compression format for encoding analog video signals.

Popular and commonly found DVR features are defined below:
1) Time shifting is the recording of programming to a storage medium to be viewed or listened to at a time more convenient to the consumer.
2) Chase play is a time shifting facility of personal video recorders that allows a user to simultaneously watch, stop or pause live television while continuing to record a program to its conclusion.
3) Instant replay is a feature of DVRs, enabling a user to quickly review recently rendered video.
4) Pausing live TV is a feature of DVRs that enables a user to stop the video and audio, and display a still frame. Often, the user may resume the audio video (A/V) content at the point they paused.
5) An Electronic Program Guide (EPG) or also an Interactive Program Guide (IPG) or Electronic Service Guide (ESG), is an on-screen guide to scheduled broadcast television programs, allowing a viewer to navigate, select, and discover content by time, title, channel, genre, etc, by use of their remote control, a keyboard, or even a phone keypad.

### SUMMARY

Embodiments of the present invention include a method providing intelligent suggestions and recommendations for wearable attire and digital video recording (DVR), the method including: receiving information for a user's apparel and accessory purchases; parsing the received information for storage in a database to form an inventory of the user's apparel and accessories; obtaining ancillary information from mass media sources, the Internet, and calendar applications; providing the received information and the obtained ancillary information to a suggestion interface; formulating recommendations with the suggestion interface for wardrobe and program recording options; wherein the wardrobe options are based on the inventory of the user's apparel and accessories; and wherein the received information comprises one or more of the following: electronic receipts for apparel and accessory purchases, radio frequency identification (RFID) tags on the apparel and accessories, and information describing the apparel and accessories supplied by manual user entry via a graphical user interface.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a functional block diagram of a system for implementing embodiments of the invention.

FIG. 2 illustrates a method flow according to embodiments of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

With the advances in digital television, and the continued growth of consumer choices in not only televisions viewing, but also in apparel, consumers often find it difficult to make daily decisions on what to wear or watch.

The choices faced by a person on their attire selection may be dependent on several factors such as weather, events, preferences etc. Presently, there is no automatic way of suggesting to a user a set of clothes, on a regular basis, based on the aforementioned factors. In addition, current digital video recorders either have to be programmed explicitly, or provide suggestions based on viewing habits, which limits the input methods through which an automated recording system is empowered with recommendation abilities.

Embodiments of the invention provide a method and system for making intelligent suggestions. The two primary suggestion components are configured for suggesting user attire and viewer program or content selection.

In embodiments of the invention, the attire suggestion component collects data about apparel and accessories available to a user, and offers daily suggestions about attires based on information gathered from various sources and online services. Embodiments of the invention create an inventory of a user's apparel or clothing from electronic receipts sent at the time of purchase, as well as through information provided by manual user input. The subsequent clothing suggestions are made based on information received by synching with other available services such as online weather and user applications such as personal calendars.

In embodiments of the invention, the television program suggestion component utilizes a user's calendar, and other documented events in the area to suggest programming to record for the user. Unlike existing recording systems that are configured to make suggestions based on a user's viewing habits and viewing history, but does not take into consideration the user's daily activities and participatory events.

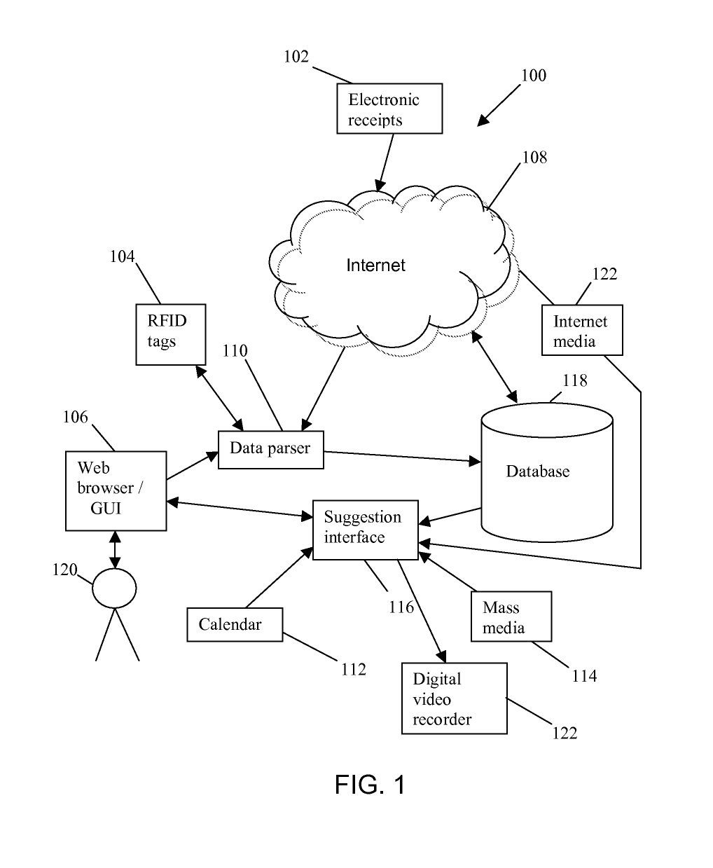

FIG. 1 is a functional block diagram of a system 100 configured for the attire suggestion component. In embodiments of the invention, apparel data for an intended user 120 is gathered automatically. Data about a user's apparel may be gathered in various existing ways including electronic receipts 102 for apparel purchases, radio frequency identification (RFID) tags 104 on the apparel, or by manual entry by the user 120 via a Web browser/Graphical. For example, a user goes shopping (in a physical retail location or online) and buys clothes, shoes, and accessories. During checkout (point of purchase), the user is provided with an option to not only get the traditional paper receipt, but also an electronic receipt in a standardized format (for parsing) that is sent to their electronic mail (email) address via the Internet. The electronic receipt is Extensible Markup Language (XML) based and contains descriptive information related to the items purchased by the user in a format that may be easily parsed. The descriptive information includes many parameters for the item purchased such as size, color, fabric, category, etc. The data parser 110 parses the gathered data into a format that is used to update a central database 118. Over time, the central database 118 accumulates an inventory of all the items purchased or owned by the user 120. The user 120 may also manually enter and update the central database 118 via the GUI 106 with wardrobe and categorization information.

Continuing with FIG. 1, data obtained from mass media sources 114 (broadcast television, radio, etc.), Internet information sources 122, calendar applications 112, as well as the accumulated data in the central database 118 is supplied to the suggestion interface 116 that provides suggestions to the user 120 via the GUI 106 on a user defined time basis, such as a daily basis. The system 100 provides the user with suggestions about what to wear or what to take along with them (e.g., depending on whether the user 120 is going for a game of golf later, a casual get together, or a formal dinner), based on the user's calendar, reported weather conditions, etc. The system 100, of embodiments of the invention, takes different parameters into consideration when making suggestions by synching with common Web information services (weather, news, etc. to determine weather forecasts for clothing choices (chances of rain/snow, temperature).

In addition, events on the user's calendar application 112 are utilized to influence suggestions made by the suggestion interface 116. Embodiments of the invention synchronize with desktop calendar applications such as International Business Machine's Lotus Notes, Microsoft's Outlook, or online calendars like those provided by Yahoo, Google and Evite to obtain user calendar information for the suggestion interface 116. Most of these existing calendar applications and services have information about various categories of events such as “interview”, “dinner”, “concert”, “movie”, etc. Some applications also allow the creation of personal categories for events. In addition, these calendar applications have a “comments” or “notes” section to make additional comments, which may be utilized by the suggestion interface in an intelligent manner. The location of an event is also an important factor to decide a user's suggested clothes. Embodiments of the invention are capable of either obtaining dress code information from the calendar entry itself, or obtaining it from a publicly available information source for the venue specified in the entry. For example, the following dress parameters may be obtained by parsing event information from calendars and made use of: casual versus formal, indoor versus outdoor, personal versus professional. In the case of an event such as a college reunion, an old college sweatshirt may be dictated, or possibly the wearing of the school's colors. Some clothes are more appropriate for a rock concert than others, etc.

Embodiments of the invention may utilize the preferences of the people who are on the user's calendar for a designated event. Typically, events on a calendar will have the other invitees or guest list associated with the event, and this information may be utilized by embodiments of the invention to influence the provided suggestions. For example, although the user wears dark suits to work; his wife likes him to wear light colored suits for dinner. Or, the user may make a note in the system that the hosts of the event have a tendency of keeping their house cold, so it might be wise to carry a jacket.

Referring again to FIG. 1, embodiments of the invention may also be configured to provide suggestions for recording programming content on a digital video recorder 122, both video and audio. Unlike existing digital video recorders (DVR) that base program selection on a user's viewing history, embodiments of the invention utilize the user's calendar of events and activities to determine programming content of interest. DVRs that are configured according to embodiments of the invention obtain television program schedule data from online, over the air, and satellite and cable television guides. Events and activities of the user are gathered from their calendar (desktop or online). Based on a user defined or daily basis, the DVR recommends or records television programs in response to the user's activities. The following are a few examples of DVR operation according to embodiments of the invention.

In the event a user has Movie Z on their calendar, which is part of a trilogy of movies (X, Y, and Z), embodiments of the invention will suggest to record X and Y if available, along with the reason for the suggestion.

In the event a user has a trip to Las Vegas scheduled on their calendar, embodiments of the invention will make suggestion to record Las Vegas related programming.

In the event a user has regular events based around a sport on their calendar, embodiments of the invention will suggest recording any related tournaments.

In the event a user is traveling to a different country based on their calendar, embodiments of the invention will suggest shows related to exploring that country.

Embodiments of the invention may be utilized for targeted advertising, where the calendar information is mixed with the user's viewing habits for determining and providing relevant advertisements to a user.

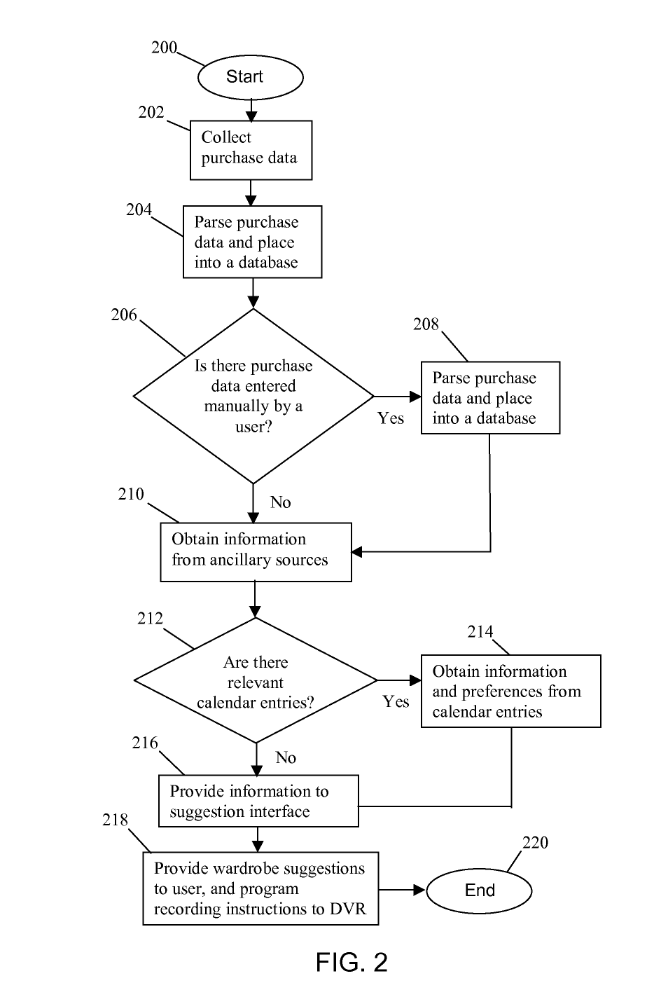

FIG. 2 illustrates a flow chart for a method for providing intelligent suggestions and recommendations for a user's wardrobe and DVR programming according to embodiments of the invention. Referring to FIG. 2, the process starts (block 200) with the collection of purchasing data (block 202), and parsing the data into a format for storage in a database (block 204). In the event there is purchase data that is also manually entered by the user (decision block 206 is Yes), the manually entered data is also parsed and stored in the database (block 208). Information is subsequently obtained from ancillary sources (block 210) including Internet and broadcast based information sources. In the event there are relevant calendar entries (decision block 206 is Yes) found in the user's desktop calendar applications or online calendars, the information is obtained from the calendar entries (block 214). The information obtained from the ancillary sources (block 210), and calendar entries (block 214) are provided to the suggestion interface (block 216), which utilizes the inputs to provide wardrobe suggestions and recommendations to the user, and program recording instructions to a DVR (block 218), and the process concludes (block 220).

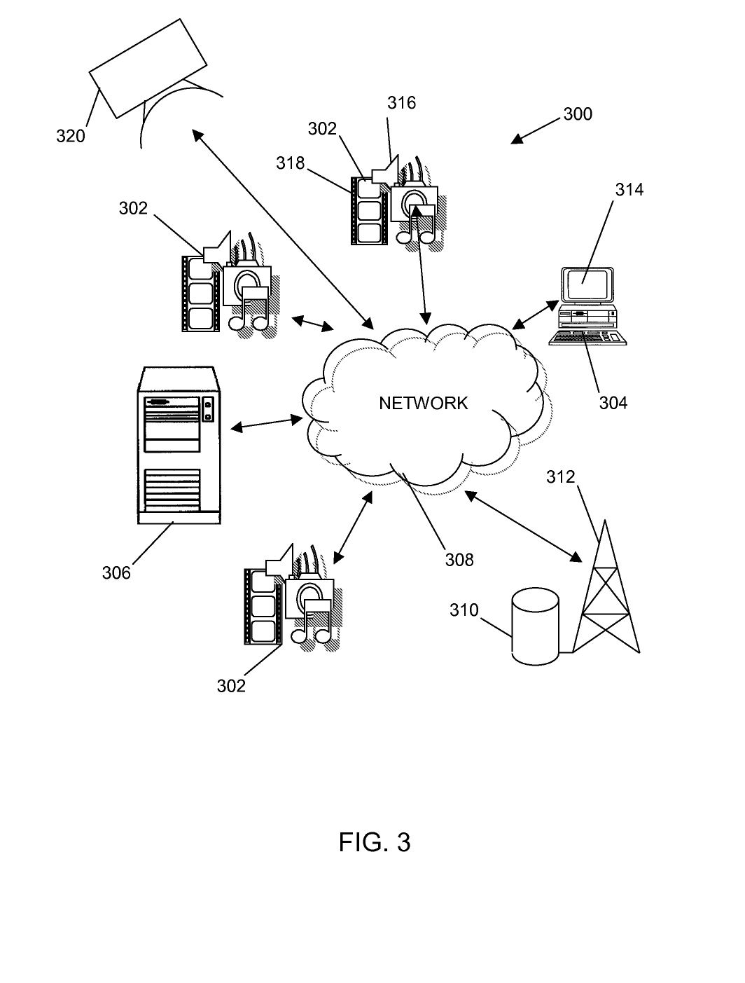

FIG. 3 is a block diagram of an exemplary system 300 configured for providing intelligent wardrobe and programming suggestions according to embodiments of the invention. The system 300 includes multimedia devices 302, and desktop computer devices 304 configured with display capabilities 314. The multimedia devices 302 may be mobile communication and entertainment devices, such as cellular phones and mobile computing devices that are wirelessly connected to a network 308. The multimedia devices 302 have video displays 318 and audio outputs 316. The multimedia devices 302 and desktop computer devices 304 may be configured with software with a GUI for carrying out aspects of embodiments of the invention. The network 308 may be any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 310 and antenna 312. In a preferred embodiment, the network 308 is a LAN and each remote device 302 and desktop device 304 executes a user interface application (e.g., web browser) to contact the server system 306 through the network 308. Alternatively, the remote devices 302 and 304 may be implemented using a device programmed primarily for accessing network 308 such as a remote client.

The intelligent suggestion software, of embodiments of the invention, may be resident on the individual multimedia devices 302 and desktop computers 304, or stored within the server 306 or cellular base station 310.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. A method for providing intelligent suggestions and recommendations for wearable attire via a computing device attached to the Internet to a user, the method comprising:
receiving information for a user's apparel and accessory purchases at the computing device;
parsing the received information for storage in a database coupled to the computing device to form an inventory of the user's apparel and accessories;
obtaining ancillary information from at the computing device the Internet and calendar applications, the Internet formation being weather information and the calendar applications including the user's planned events;
providing the received information and the obtained ancillary information to a suggestion interface;
formulating at the suggestion interface recommendations with the suggestion interface for wardrobe and options based on the weather information received from the Internet and events contained in the calendar application;
providing the recommendations to the user via a graphical user interface coupled to the computing device;
wherein the wardrobe options are based on the inventory of the user's apparel and accessories; and
wherein the received information comprises one or more of the following: electronic receipts for apparel and accessory purchases, radio frequency identification (RFID) tags on the apparel and accessories, and information describing the apparel and accessories supplied by manual user entry via a graphical user interface.
